(19) United States
(12) Patent Application Publication
(10) Pub. No.: US 2007/0101122 A1
(43) Pub. Date: May 3, 2007

(54) Method and apparatus for securely generating application session keys

(76) Inventor: Yile Guo, Carrollton, TX (US)

Correspondence Address: DITTHAVONG & MORI, P.C., Suite A, 10507 Braddock Road, Fairfax, VA, 22032, US

(21) Appl. No.: 11/526,386

(22) Filed: Sep. 25, 2006

Related U.S. Application Data
(60) Provisional application No. 60/719,752, filed on Sep. 23, 2005.

(51) Int. Cl. H04L 9/00

(52) U.S. Cl. 713/153

(57) ABSTRACT

An approach is provided for securely generating application session keys within a secure module of a user terminal. The secure module includes a secure memory and a secure processor configured to perform session key generation. The secure module is configured to send the session keys to a mobile equipment.

### RELATED APPLICATIONS

This application claims the benefit of the earlier filing date under 35 U.S.C. §119(e) of U.S. Provisional Application Ser. No. 60/719,752 filed Sep. 23, 2005, entitled “Method and Apparatus for Securely Generating Application Session Keys”; the entirety of which is incorporated by reference.

### FIELD OF THE INVENTION

Embodiments of the invention relate to communications, and more particularly, to supporting secure communications in a wireless network.

### BACKGROUND

Radio communication systems, such as cellular systems (e.g., spread spectrum systems (such as Code Division Multiple Access (CDMA) networks), or Time Division Multiple Access (TDMA) networks), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One key area of effort involves supporting secure communications between mobile devices and the network through the use of session keys. Unfortunately, conventional systems do not provide effective security for generating these session keys.

Therefore, there is a need for an approach to securely generate session keys.

Some Exemplary Embodiments

These and other needs are addressed by the embodiments of the invention, in which an approach is presented for securely generating application session keys.

According to one aspect of an embodiment of the invention, a method comprises generating a session key, within a secure module of a communication device, to secure a communication session. The method also comprises forwarding the session key to an unsecure module of the communication device. The unsecure module is configured to execute an application that uses the session key to establish the communication session.

According to another aspect of an embodiment of the invention, an apparatus comprises a secure processor configured to generate a session key to secure a communication session, wherein the session key is forwarded to an unsecure module. The unsecure module is configured to execute an application that uses the session key to establish the communication session.

According to another aspect of an embodiment of the invention, an apparatus comprises a secure module configured to generate a session key to secure a communication session. The apparatus also comprises an unsecure module configured to receive the session key and to execute an application that uses the session key to establish the communication session.

According to another aspect of an embodiment of the invention, a method comprises generating a request, by an application resident within an unsecure module of a communication device, for a session key to secure a communication session. The method also comprises forwarding the request to a secure module of the communication device, the secure module being configured to generate the session key in response to the request. The application resident within the unsecure module uses the session key to establish the communication session.

According to another aspect of an embodiment of the invention, an apparatus comprises a non-secure processor configured to run an application to generate a request for a session key to secure a communication session, wherein the request is forwarded to a secure module that is configured to generate the session key in response to the request. The application resident within the unsecure module uses the session key to establish the communication session.

According to yet another aspect of an embodiment of the invention, an apparatus comprises means for securely generating a session key to provide security for a communication session; and means for forwarding the session key to an unsecure module that is configured to execute an application that uses the session key to establish the communication session.

Still other aspects, features, and advantages of the embodiments of the invention are readily apparent from the following detailed description, simply by illustrating a number of particular embodiments and implementations, including the best mode contemplated for carrying out the embodiments of the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings and in which like reference numerals refer to similar elements and in which:

FIG. 1 is a diagram of an exemplary bootstrapping architecture capable of securely generating session keys, in accordance with various embodiments of the invention;

FIGS. 2A-2D are exemplary configurations of a secure module and an unsecure module for securely generating and processing session keys, according to an embodiment of the invention;

FIGS. 3A and 3B are flowcharts of processes for generating session keys, according to various embodiments of the invention;

FIG. 4 is a flowchart of a session key generating process utilizing a Transport Layer Security (TLS)-Pre-Shared Key (PSK) procedure, according to an embodiment of the invention;

FIG. 5 is a diagram of hardware that can be used to implement various embodiments of the invention;

FIGS. 6A and 6B are diagrams of different cellular mobile phone systems capable of supporting various embodiments of the invention;

FIG. 7 is a diagram of exemplary components of a mobile station capable of operating in the systems of FIGS. 6A and 6B, according to an embodiment of the invention; and

FIG. 8 is a diagram of an enterprise network capable of supporting the processes described herein, according to an embodiment of the invention.

### DESCRIPTION OF THE PREFERRED EMBODIMENT

An apparatus, method, and software for providing key provisioning procedures within a secure module (e.g., user identity module (UIM)) of user terminal are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a spread spectrum system, it is recognized by one of ordinary skill in the art that the embodiments of the inventions have applicability to any type of radio communication system as well as terrestrial networks. Additionally, it is contemplated that the protocols and processes described herein can be performed not only by mobile and/or wireless devices, but by any fixed (or non-mobile) communication device (e.g., desktop computer, network appliance, etc.) or network element or node.

Various embodiments of the invention relate to session key derivation and provisioning in spread spectrum networks, such as 3GPP (Universal Mobile Telecommunications System (UMTS)) and 3GPP2 (cdma2000). The invention, according to one embodiment, provides procedures for the support for cdma2000 IP data connectivity and mobility in wireless networks utilizing 3^{rd} Generation Partnership Project (3GPP2) Generic Bootstrapping Architecture (GBA) finctionality in Code Division Multiple Access (CDMA) EV-DO (Evolution Data-Only) networks. By way of example, exemplary bootstrapping procedures are defined in 3GPP TS 33.220, 3GPP TS 24.109 and 3GPP2 S.P0109, which are incorporated herein by reference in their entireties.

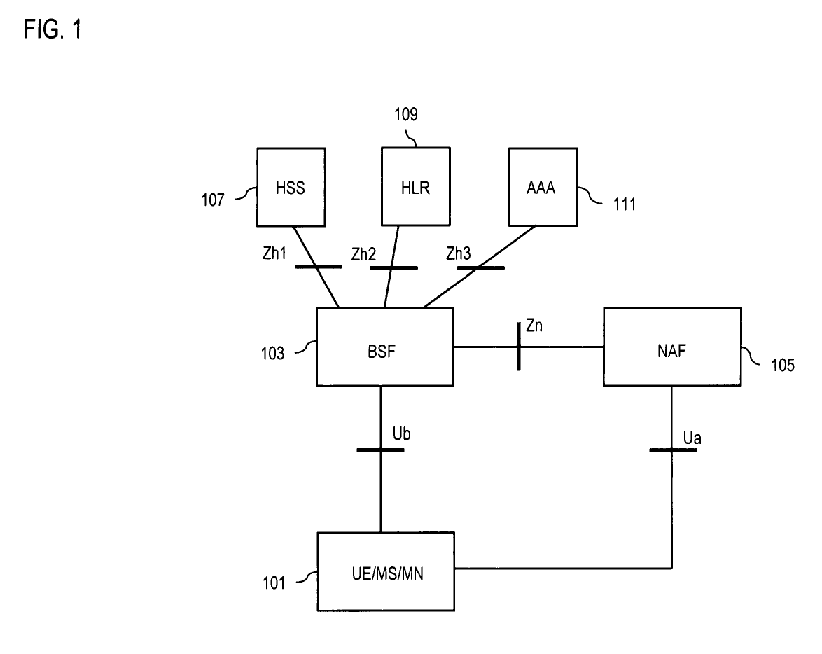

FIG. 1 is a diagram of an exemplary bootstrapping architecture capable of securely generating session keys, in accordance with various embodiments of the invention. By way of illustration, the bootstrapping architecture 100 is explained in the context of the Generic Bootstrapping Architecture (GBA) in 3GPP2 (Third Generation Partnership Project 2). GBA is one component of the Generic Authentication Architecture (GAA) defined in 3GPP/3GPP2 (Third Generation Partnership Project/Third Generation Partnership Project 2). The basic elements include an UE (User Equipment) 101, a Bootstrapping Server Function (BSF) 103, which is responsible for the bootstrapping, and a Network Application Function (NAF) 105. The NAF 105, in an exemplary embodiment, can be hosted in any type of network element, such as a server; the NAF 105 accordingly can serve as an application server that the UE 101 communicates with in using the derived security keys. As used herein, the term “application” (according to various embodiments) refers to a communication service, and is not limited to an actual instance of an application within the application server.

The BSF 103 handles subscriber's bootstrapping information after the bootstrapping procedure in the system 100. The bootstrapping procedure creates security association between the UE 101 and the BSF 103. Using the stored user's bootstrapping information and the security association, the BSF 103 can provide secure services to network application finctions (such as NAF 105) contacted by the UE 101. As used herein, “secure services” involves providing services in a secure manner. Bootstrapping can be performed between the UE 101 and the BSF 103 based on, for instance, a long term shared secret maintained between the UE 101 and the network. After the bootstrapping has been completed, the UE 101 and the NAF 105 can run some application specific protocol where the authentication, or in general, security, of messages will be based on session keys derived from the key agreed on during bootstrapping. Security of messages includes but is not limited to authentication, authorization, confidentiality, and integrity protection.

The BSF 103 and the UE 101 mutually authenticate and agree on a key that are afterwards used to derive session keys for use between the UE 101 and the NAF 105. The BSF 103 can restrict the applicability of the key material to a specific NAF (e.g., NAF 105) by using a key derivation procedure. In an exemplary embodiment, after the bootstrapping procedure, both the UE 101 and the BSF 103 have agreed on the key material (Ks), a bootstrapping transaction identifier (B-TID), a key material lifetime, and other parameters, the key material corresponding to the NAF 105 (denoted “Ks_NAF”) and B-TID may be used in the Ua interface to mutually authenticate and optionally secure traffic between the UE 101 and the NAF 105. The terms “mobile station (MS),” “user equipment (UE),” “user terminal,” and “mobile node (MN),” are used interchangeably depending on the context to denote any type of client device or terminal. For example, the 3GPP standard employs the term UE, and the 3GPP2 standard adopts MS; while MN is used in a mobile Internet Protocol (IP)-related context. The UE 101, for example, can be a mobile communications device or mobile telephone, or other wireless devices. The UE 101 can also be such devices as personal digital assistants (PDA) with transceiver capability or personal computers with transceiver capability. The UE 101 transmits and receives using wireless communications transceivers to communicate with the BSF 103. The BSF 103 transmits to and receives data from home location register 109.

As shown, a number of reference points, Ub, Ua, Zh1, Zh2, Zh3 and Zn, are defined to support the bootstrapping system 100. The reference point Ub provides mutual authentication between the UE 101 and the BSF 103, permitting the UE 101 to bootstrap the key material Ks. The Ua interface carries the application protocol, which is secured by the key materials derived from the agreed key materials, Ks, between the UE 101 and the BSF 103. The Zh1, Zh2, and Zh3 reference points are utilized to exchange the required authentication information and user security settings between the BSF 103 and the Home Subscriber System (HSS) 107 (in which Authentication and Key Agreement (AKA) is used in bootstrapping), a Home Location Register (HLR) 109 (in which CAVE (Cellular Authentication and Voice Encryption) algorithm can be used to bootstrap), and an Authentication, Authorization and Accounting (AAA) server 107 (in which MN-AAA key is used in bootstrapping). The Zn interface allows the NAF 105 to fetch the derived key material and application-specific user security settings from the BSF 103.

The GBA operations, according to an exemplary embodiment, are as follows. A bootstrapping procedure is performed between the UE 101 and the BSF 103 (which is located in the home network). During bootstrapping, mutual authentication is performed between the MS 101 and the network based on a long term shared secret between the MS 101 and the home network. For example, in 3GPP2, this long term shared secret may be stored in the HSS 107, the HLR 109, and the AAA server 107. In 3GPP, bootstrapping is based either on AKA or Subscriber Identity Module (SIM) authentication. As a result of the bootstrapping procedure, a bootstrapping key, Ks, is generated by both the MS 101 and the BSF 103. The Ks is also associated with a Bootstrapping Transaction Identifier (B-TID) and a lifetime, which provides a value relating to expiration or duration of the key, Ks.

As a next step, the MS 101 indicates to an application finction in the network, referred to as the NAF 105, that GBA can be used for providing a shared secret for the application. Alternatively, the NAF 105 can indicate to the MS 101 that GBA is to be used. Thereafter, the NAF 105 retrieves the Ks of the NAF 105 (denoted as “Ks-NAF”) from the BSF 103; concurrently, the MS 101 derives the same Ks_NAF. The Ks_NAF is then used as the shared secret between the MS 101 and the NAF 105 for any fuirther security operations. For added security, keys are refreshed, either periodically or on demand.

As mentioned above, BSF 103 and MN 101 mutually authenticate and agree on session keys that are afterwards applied between MN 101 and a Network Application Function (NAF) 105. For bootstrapping based on ME-AAA (Authentication Authorization and Accounting), the BSF 103 shall be capable of obtaining the MN-AAA associated with the MN 101 from the AAA 111. The BSF 103 can restrict the applicability of the key material to a specific NAF 105 by using a key derivation procedure. After the bootstrapping has been completed, the MN 101 and a NAF 105 can run some application specific protocol where the authentication of messages will be based on those session keys generated during the mutual authentication between MN 101 and BSF 103.

The BSF 103 handles subscriber's bootstrapping information after bootstrapping procedure in an authentication architecture system. The bootstrapping procedure creates security association between the MN 101 and the BSF 103. Using the stored user's bootstrapping information and the security association the BSF 103 can provide security services to network application finctions contacted by the MN 101.

As indicated previously, a mobile communication system comprises of many user equipment terminals. MN 101 can also be known as mobile devices, mobile stations, and mobile communications devices. The MN 101 can be a mobile communications device or mobile telephone, or other wireless devices. The MN 101 can also be such devices as personal digital assistants (PDA) with transceiver capability or personal computers with transceiver capability. The MN 101 transmits and receives using wireless communications transceivers to communicate with the BSF 103. The BSF 103 transmits to and receives data from home location register/access channel (HLR/AC) 109. For bootstrapping based on AKA (Authentication and Key Agreement), the BSF 103 shall be capable of obtaining an Authentication Vector from the HLR (Home Location Register) 109 or HSS (Home Subscriber System) 111.

Although the key provisioning approach, according to various exemplary embodiments, are discussed in the context of a wireless network environment, the approach can be applied to other environments, such as interworking between CDMA2000 and WiMax (Worldwide Interoperability for Microwave Access) access, or interaction between 3GPP networks and WLAN IW or WiMax accesses.

It is recognized that many mobile applications require secure communication between a client (e.g., in a mobile device) and a server (in the network). Consequently, secure sessions for these applications are established between the client and the server. The secure sessions can be protected by session keys (or session secrets) that are shared between the client and the server.

In an exemplary embodiment, secure sessions are established using the Transport Layer Security (TLS) as defined in Internet Engineering Task Force (IETF) Request for Comment (RFC) 2246, which is incorporated herein by reference in its entirety. TLS used in the context of Pre-Shared Keys is denoted as TLS-PSK, as specified in IETF (work in progress).

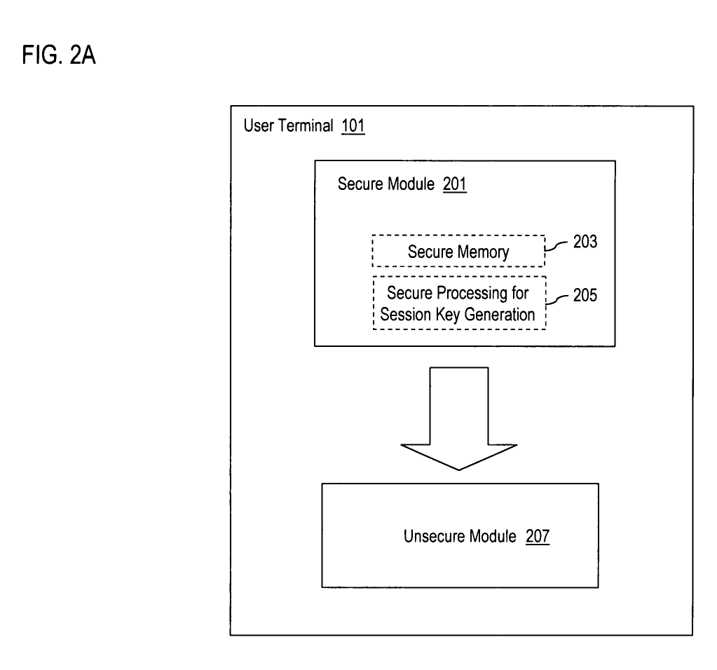

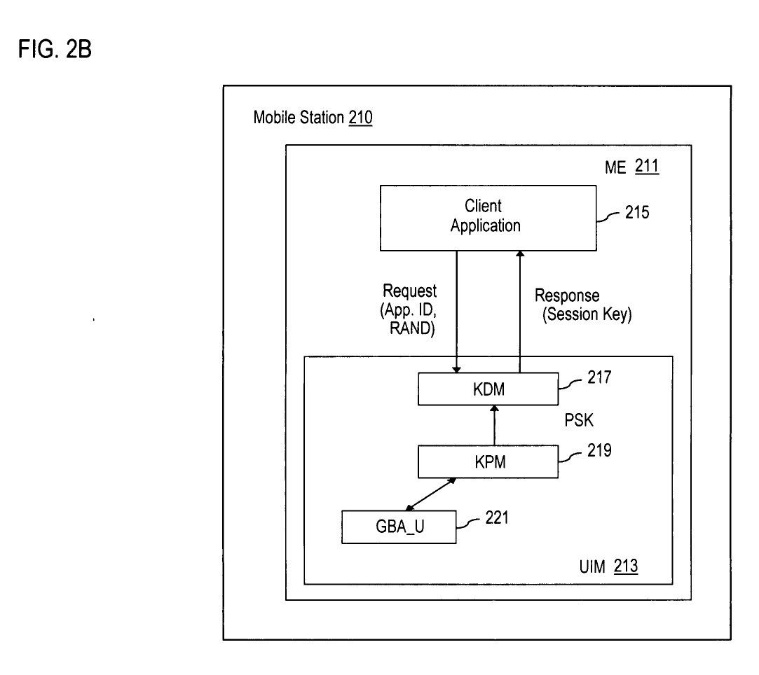

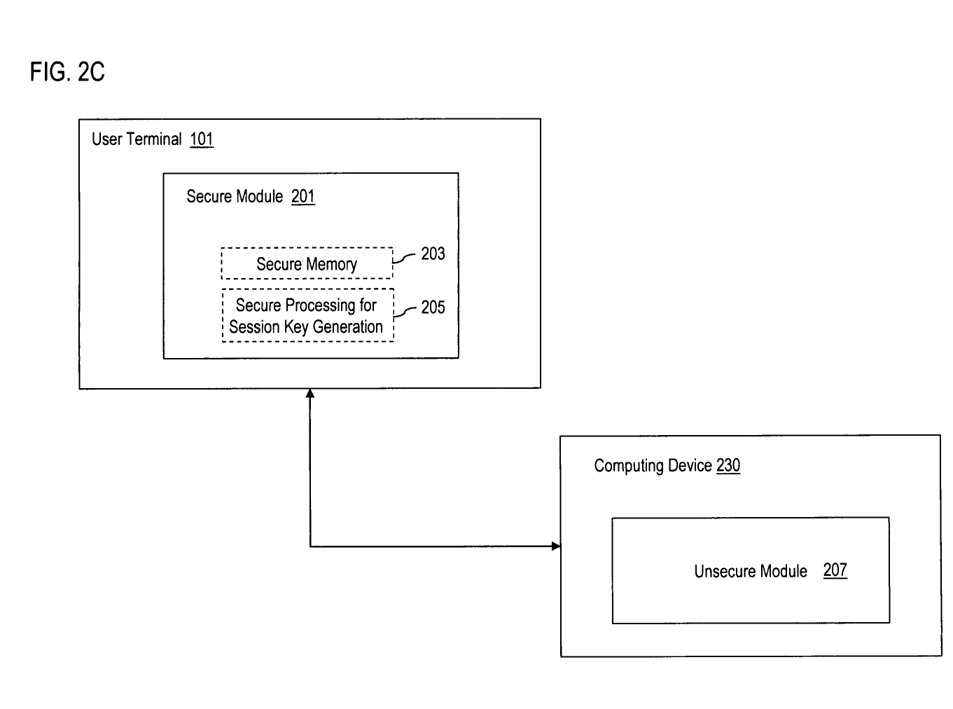

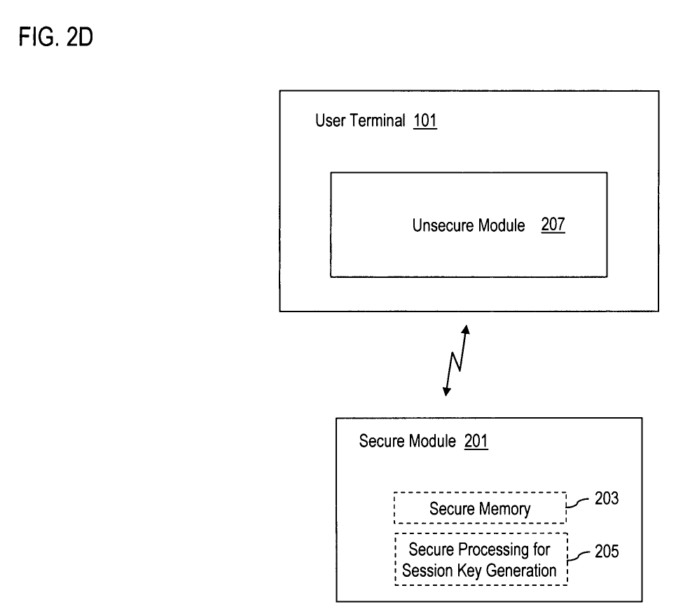

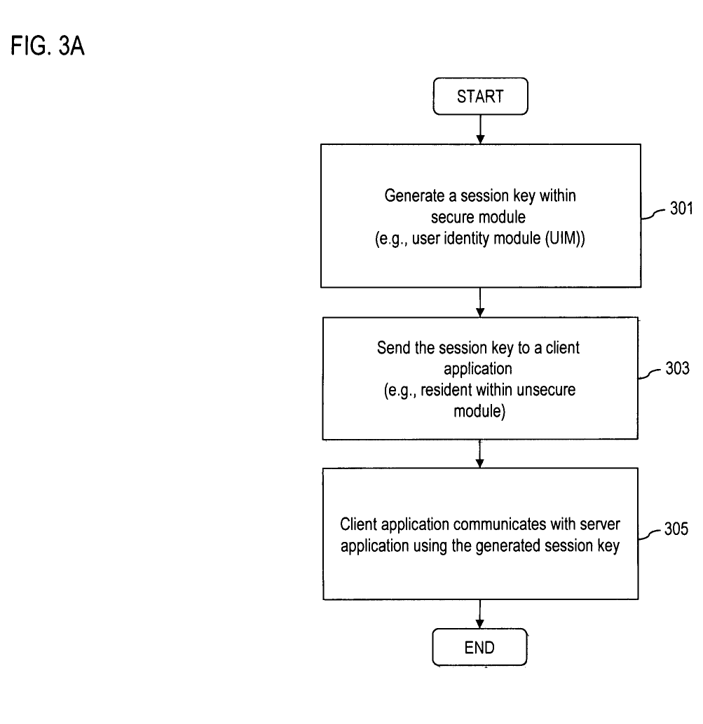

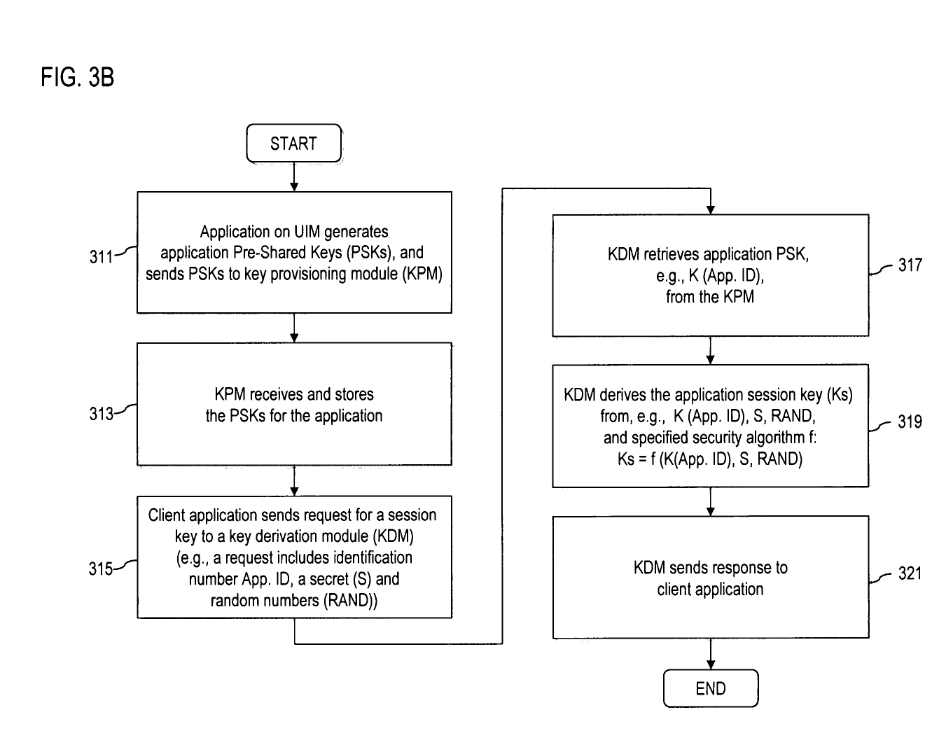

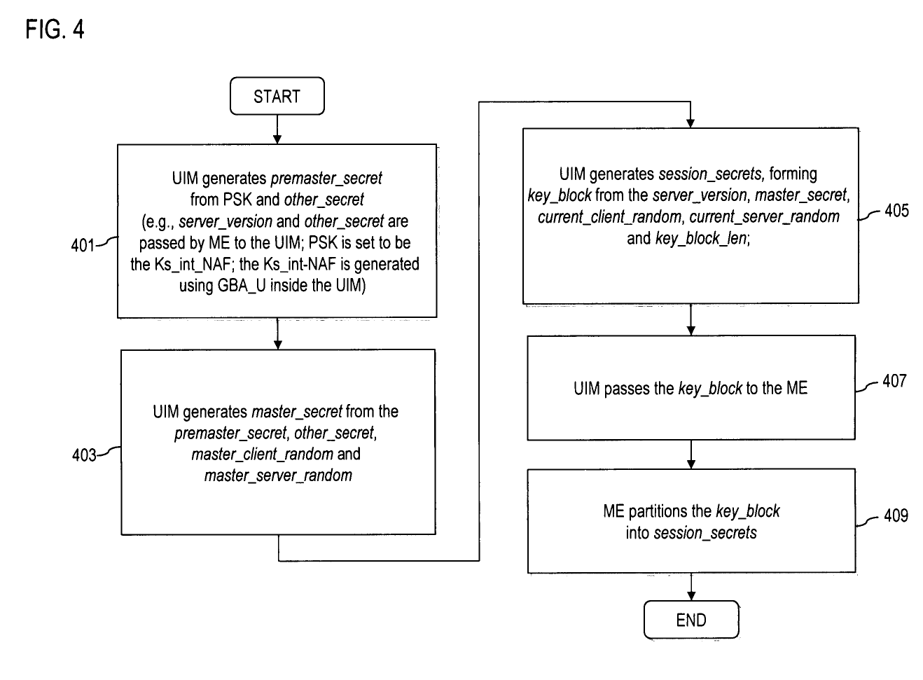

FIGS. 2A-2D are exemplary configurations of a secure module and an unsecure module for securely generating and processing session keys, according to an embodiment of the invention. By way of illustration, a secure module 201 utilizes a low power processor, and the unsecure module 207 utilizes a high power processor. The secure module 201 comprises a secure memory 203, and a secure processor 205 that is configured to perform session key generation (this process is more fully described below with respect to FIGS. 3 and 4). Also, in an exemplary embodiment, the unsecure module 207 can execute client applications, which require session keys that are output from the secure processor 205.

In another embodiment, as shown in FIG. 2B, a mobile station (MS) 210 includes a mobile equipment (ME) 211 in communication with a User Identity Module (UIM) 213. Essentially, the ME 211 can be an unsecure module, while the UIM 213 is a secure module. Accordingly, the UIM 213 is a low power processor that contains secure memory and secure processing logic or circuitry. The UIM 213 may be, for instance, a Universal Integrated Circuit Card (UICC), Subscriber Identity Module (SIM), Removable User Identity Module (R-UIM) or embedded in the Mobile Station. The UIM 213 can be a standardized device or finctionality that provides secure procedures in support of, for example, registration, authentication, and privacy for wireless access network. According to one embodiment of the invention, the ME 211 contains a high power processor that does not contain a secure memory or possess secure processing capability.

For mobile applications, a client application 215 can run in the ME 211. Therefore, the application session keys is either generated in the ME 211 or sent to the ME 211 by the UIM 213. By way of example, these session keys can be derived from the Pre-Shared Key (PSK) shared between the user terminal 101 (e.g., acting as a client) and a server (not shown).

Generating session keys in the ME 211 would require an application PSK to be stored either in the ME 211 or sent to the ME 211 by the UIM 213. As the ME 211 does not contain secure memory or secure processing, the application PSK could conceivably be obtained by attackers. This vulnerability significantly weakens the security of the communication between the client and the server. Notably, in a system whereby GBA_ME is supported, the application PSK is provisioned and stored in the ME 211. The session keys are derived in the ME 211 from the application PSK. As the ME 211 may not contain secure memory or secure processing, the application PSK could be obtained by the attackers.

Also in a system in which GBA_U 221 is used, the application PSK is provisioned and stored in the UIM 213. However, the application PSK is sent to the ME 211 and the session keys are derived in the ME 211. Again, because the ME 211 is devoid of secure memory or secure processing, the application PSK is vulnerable to attackers.

The approach, according to various embodiments of the invention, mitigates or eliminates the above security issue. That is, the approach generates session keys in the UIM 213 (which contains secure memory and secure processing), and sends the session keys to the ME 211. Under this approach, the application PSK is not external to the UIM 213, thereby advantageously providing highly secure communication between the client and the server.

As shown in FIG. 2C, the secure module 201 can be physically separated from the unsecure module 207. That is, these modules can reside within separate physical devices (or housings). Under this scenario, the user terminal 101 houses the secure module 201, while the unsecure module 207 resides in a separate computing device 230, which can be a laptop computer, desktop computer, a PDA, etc. The communication between the user terminal 101 and the computer device 230 can be implemented as a wired connection or a wireless connection.

Alternatively, as illustrated in FIG. 2D, the secure module 201 can be a standalone device, such as a smartcard with a wireless connection, Radio Frequency Identification (RFID) card, etc. In this example, the unsecure module 207 is implemented in the user terminal 101.

Thus, with each of the above configurations, a session key can be generated securely, as next explained.

FIG. 3A is a flowchart of process for generating session key by the terminal of FIG. 2A, according to various embodiments of the invention. For the purposes of illustration, this session key generation process is described with respect to the user terminal 101 of FIG. 2A. The secure module 201, per step 301, generates a session key within secure module 201 (e.g., User Identify Module (UIM)). After performing session key generation, as in step 303, the secure module 201 sends the session key to a client application which resides within an unsecure module 207. Thereafter, a client application (not shown) communicates with the secure module 201 (e.g., server application) using the generated session key (step 305).

FIG. 3B is a flowchart of process for generating session key by the terminal of FIG. 2B, according to various embodiments of the invention. As seen in FIG. 2B, a Key Derivation Module (KDM) 217 and a Key Provisioning Module (KPM) 219 are applications on the UIM 213. Per step 311, the application on the UIM 213 (such as a GBA application denoted as “GBA_U”) generates the application Pre-Shared Key (PSK) and sends them to the KPM 219. The KPM 219 receives the application PSKs, as in step 313, from the GBA_U 221 and stores PSKs for the applications. It is contemplated that the PSK can be provided using mechanisms other than the GBA process; for instance, the pre-shared key can be manually provided or sent from other network elements.

According to one embodiment of the invention, key derivation within the UIM 213 is as follows. Two options exist for use of the key derived by GBA, when GBA_U 221 is employed. First, the PSK is set to be an external Ks of the NAF 105 (denoted as “Ks_ext_NAF”). In this case, the PSK is sent by the UIM 213 to the ME 211 (which does not contain secure memory or secure processing). Second, the PSK is set to be an internal Ks of the NAF 105 (denoted as “Ks_int_NAF”). In this scenario, the PSK is derived inside the UIM 213, which contains secure memory and secure processing. The PSK is never sent outside of UIM 213.

In step 315, when the client application 215 needs a session key, the application 215 sends a request to the KDM 217; the request can specify an application identification number (Application ID), a secret (S) and a set of random numbers (RAND). The random numbers can be generated by the application or provided by the server. In step 317, the KDM 217 retrieves the application PSK K(App.ID) from the KPM 219. Next, the KDM 217 derives, as in step 319, the application session key Ks, from the K(App. ID), S, RAND, and the specified security algorithm f:
Ks=f(K(App. ID), S, RAND).

Thereafter, the KDM 217 sends a response to the client application 215 with the application session key Ks, per step 321.

In an exemplary embodiment, the interface between the client application 215 and the KDM 217 are more fully described in the UIM-ME interface specification in 3GPP2 and 3GPP, for example. It is noted that the interface between the KDM 217 and the KPM 219 can be an UIM internal interface (and need not to be compliant with the UIM-ME interface specification). Likewise, the interface between KPM 219 and key bootstrapping module (e.g. GBA-U 221) can be an UIM internal interface.

FIG. 4 provides a flowchart of a session key generating process utilizing a Transport Layer Security (TLS)-Pre-Shared Key (PSK) procedure, according to an embodiment of the invention. In an exemplary embodiment, the mobile station 210 employs a TLS-PSK procedure. For TLS-PSK, a client runs on the mobile station 210. In step 401, the UIM 213 generates a premaster secret (denoted as “premaster_secret”) from the PSK, and another secret (denoted as “other_secret”) as follows. For example, if a server version of secret is from a predetermined set −e.g., server_version={3,1}, then the premaster_secret is formed as follows: if the PSK is N octets long, concatenate a unit 16 with the value N, the other_secret, a second unit 16 with the value N, and the PSK itself. The server_version and other_secret are passed by ME 211 to the UIM 213. The PSK is set to be the Ks_int_NAF. The Ks_int_NAF is generated using GBA_U inside the UIM 213.

In step 403, the UIM 213 generates a master secret (denoted as “master_secret”) from the premaster_secret, other_secret, master_client_random and master_server_random as specified, for example, in RFC 2246, entitled “The TLS Protocol Version 1,” which is incorporated herein by reference in its entirety. The premaster_secret is generated in the UIM 213. The other_secret, master_client_random and master_server_random are passed by the ME 211 to the UIM 213.

Next, session secrets are generated. Specifically, in step 405, the UIM 213 forms key_block from the server_version, master_secret, current_client_random, current_server_random and key_block_len as described in RFC 2246. The server_version, current_client_random, current_server_random and key_block_len are passed by ME 211 to the UIM 213.

In step 407, the UIM 213 passes the key_block to the ME 211. The ME 211 then partitions, as in step 409, the key_block into session_secrets as specified in RFC 2246. The ME 211 is thus ready to send and receive application data.

The above process advantageously provides highly secure communication between a terminal (e.g., client) and the network (e.g., server).

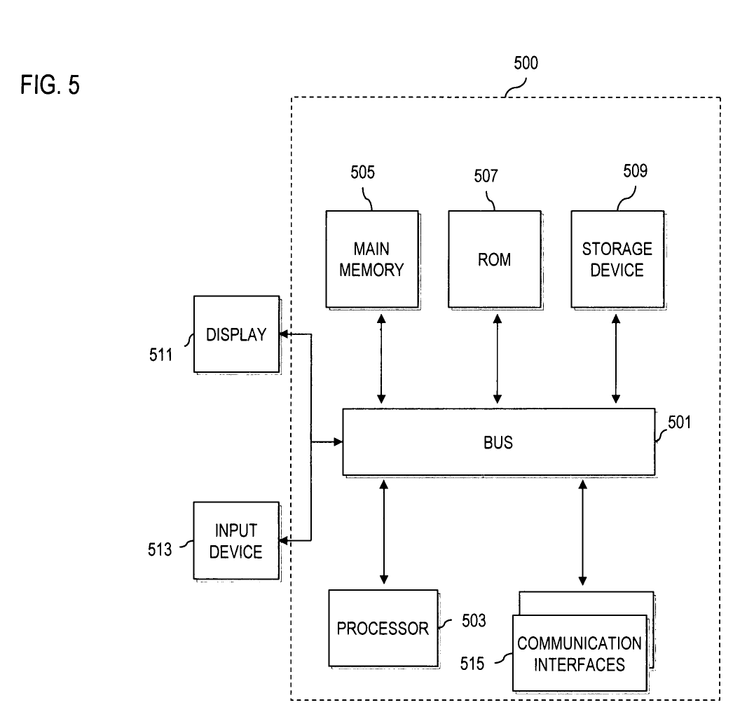

One of ordinary skill in the art would recognize that the processes for providing key derivation may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 5.

FIG. 5 illustrates exemplary hardware upon which various embodiments of the invention can be implemented. A computing system 500 includes a bus 501 or other communication mechanism for communicating information and a processor 503 coupled to the bus 501 for processing information. The computing system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computing system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computing system 500 may be coupled via the bus 501 to a display 511, such as a liquid crystal display, or active matrix display, for displaying information to a user. An input device 513, such as a keyboard including alphanumeric and other keys, may be coupled to the bus 501 for communicating information and command selections to the processor 503. The input device 513 can include a cursor control, such as a mouse, a trackball, or cursor direction keys, for communicating direction information and command selections to the processor 503 and for controlling cursor movement on the display 511.

According to various embodiments of the invention, the processes described herein can be provided by the computing system 500 in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 500 also includes at least one communication interface 515 coupled to bus 501. The communication interface 515 provides a two-way data communication coupling to a network link (not shown). The communication interface 515 sends and receives electrical, electromagnetic, or optical signals that carry digital data streams representing various types of information. Further, the communication interface 515 can include peripheral interface devices, such as a Universal Serial Bus (USB) interface, a PCMCIA (Personal Computer Memory Card International Association) interface, etc.

The processor 503 may execute the transmitted code while being received and/or store the code in the storage device 509, or other non-volatile storage for later execution. In this manner, the computing system 500 may obtain application code in the form of a carrier wave.

The term “computer-readable medium” as used herein refers to any medium that participates in providing instructions to the processor 503 for execution. Such a medium may take many forms, including but not limited to non-volatile media, volatile media, and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

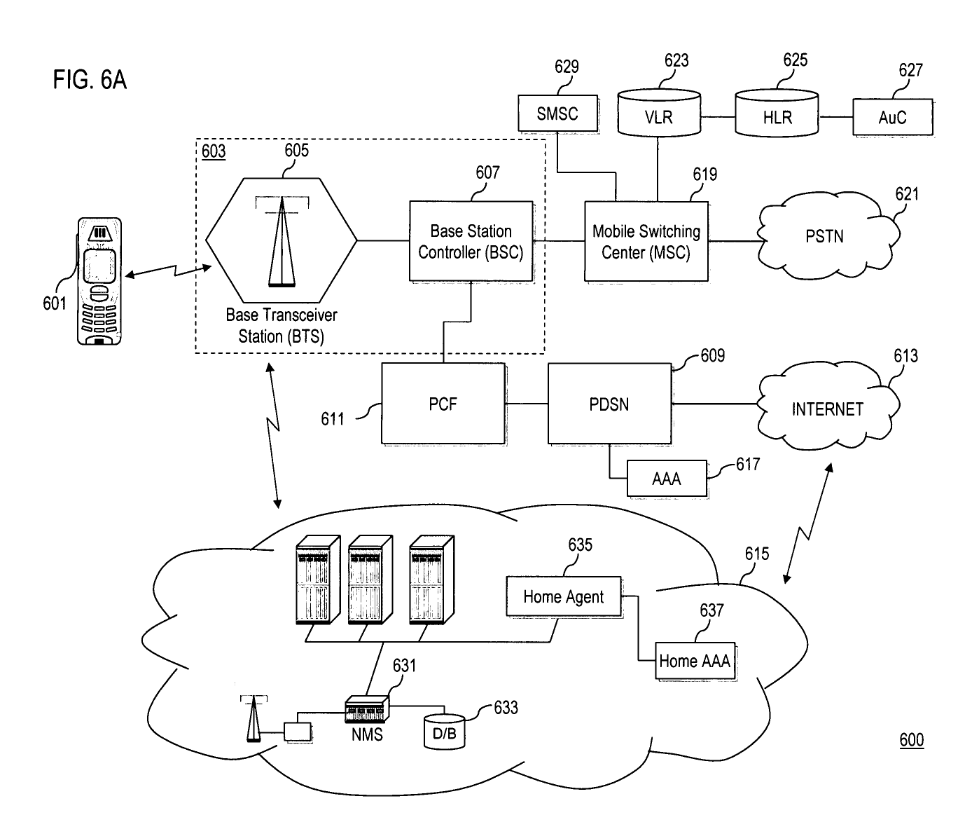

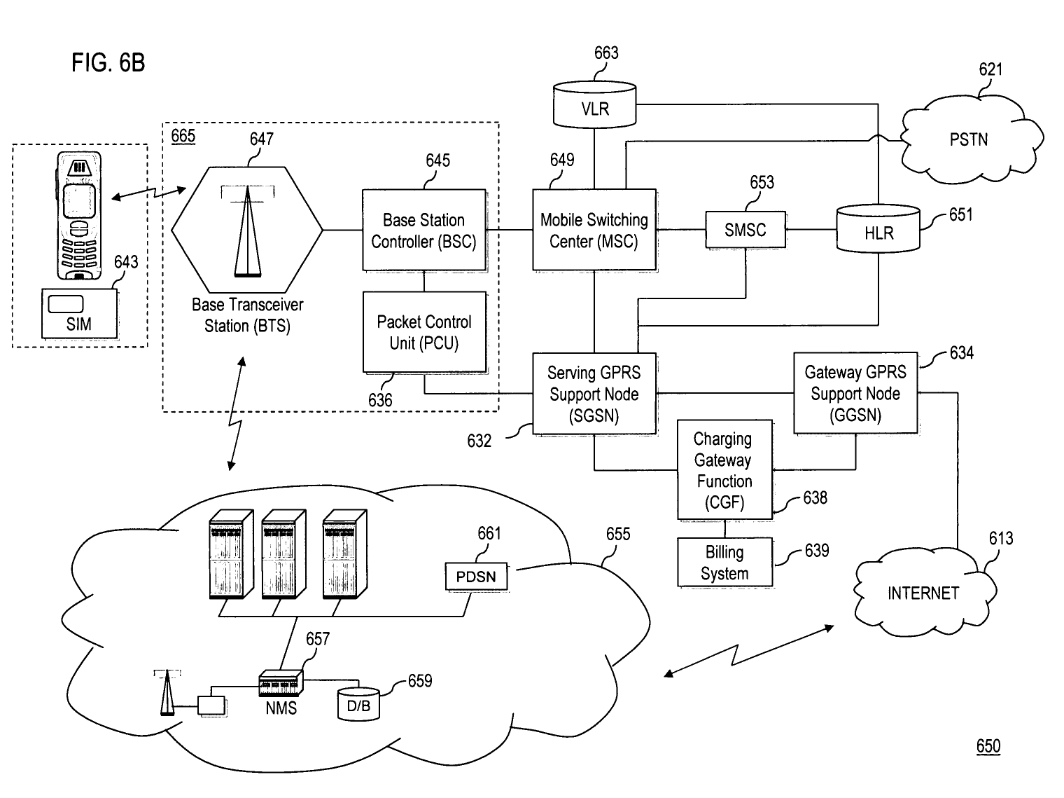

FIGS. 6A and 6B are diagrams of different cellular mobile phone systems capable of supporting various embodiments of the invention. FIGS. 6A and 6B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 600 includes mobile stations 601 (e.g., handsets, terminals, stations, units, devices, or any type of interface to the user (such as “wearable” circuitry, etc.)) in communication with a Base Station Subsystem (BSS) 603. According to one embodiment of the invention, the radio network supports Third Generation (3G) services as defmed by the International Telecommunications Union (ITU) for International Mobile Telecommunications 2000 (IMT-2000).

In this example, the BSS 603 includes a Base Transceiver Station (BTS) 605 and Base Station Controller (BSC) 607. Although a single BTS is shown, it is recognized that multiple BTSs are typically connected to the BSC through, for example, point-to-point links. Each BSS 603 is linked to a Packet Data Serving Node (PDSN) 609 through a transmission control entity, or a Packet Control Function (PCF) 611. Since the PDSN 609 serves as a gateway to external networks, e.g., the Internet 613 or other private consumer networks 615, the PDSN 609 can include an Access, Authorization and Accounting system (AAA) 617 to securely determine the identity and privileges of a user and to track each user's activities. The network 615 comprises a Network Management System (NMS) 631 linked to one or more databases 633 that are accessed through a Home Agent (HA) 635 secured by a Home AAA 637.

Although a single BSS 603 is shown, it is recognized that multiple BSSs 603 are typically connected to a Mobile Switching Center (MSC) 619. The MSC 619 provides connectivity to a circuit-switched telephone network, such as the Public Switched Telephone Network (PSTN) 621. Similarly, it is also recognized that the MSC 619 may be connected to other MSCs 619 on the same network 600 and/or to other radio networks. The MSC 619 is generally collocated with a Visitor Location Register (VLR) 623 database that holds temporary information about active subscribers to that MSC 619. The data within the VLR 623 database is to a large extent a copy of the Home Location Register (HLR) 625 database, which stores detailed subscriber service subscription information. In some implementations, the HLR 625 and VLR 623 are the same physical database; however, the HLR 625 can be located at a remote location accessed through, for example, a Signaling System Number 7 (SS7) network. An Authentication Center (AuC) 627 containing subscriber-specific authentication data, such as a secret authentication key, is associated with the HLR 625 for authenticating users. Furthermore, the MSC 619 is connected to a Short Message Service Center (SMSC) 629 that stores and forwards short messages to and from the radio network 600.

During typical operation of the cellular telephone system, BTSs 605 receive and demodulate sets of reverse-link signals from sets of mobile units 601 conducting telephone calls or other communications. Each reverse-link signal received by a given BTS 605 is processed within that station. The resulting data is forwarded to the BSC 607. The BSC 607 provides call resource allocation and mobility management functionality including the orchestration of soft handoffs between BTSs 605. The BSC 607 also routes the received data to the MSC 619, which in turn provides additional routing and/or switching for interface with the PSTN 621. The MSC 619 is also responsible for call setup, call termination, management of inter-MSC handover and supplementary services, and collecting, charging and accounting information. Similarly, the radio network 600 sends forward-link messages. The PSTN 621 interfaces with the MSC 619. The MSC 619 additionally interfaces with the BSC 707, which in turn communicates with the BTSs 605, which modulate and transmit sets of forward-link signals to the sets of mobile units 601.

As shown in FIG. 6B, the two key elements of the General Packet Radio Service (GPRS) infrastructure 650 are the Serving GPRS Supporting Node (SGSN) 632 and the Gateway GPRS Support Node (GGSN) 634. In addition, the GPRS infrastructure includes a Packet Control Unit PCU (636) and a Charging Gateway Function (CGF) 638 linked to a Billing System 639. A GPRS the Mobile Station (MS) 641 employs a Subscriber Identity Module (SIM) 643.

The PCU 636 is a logical network element responsible for GPRS-related fluctions such as air interface access control, packet scheduling on the air interface, and packet assembly and re-assembly. Generally the PCU 636 is physically integrated with the BSC 645; however, it can be collocated with a BTS 647 or a SGSN 632. The SGSN 632 provides equivalent functions as the MSC 649 including mobility management, security, and access control functions but in the packet-switched domain. Furthermore, the SGSN 632 has connectivity with the PCU 636 through, for example, a Fame Relay-based interface using the BSS GPRS protocol (BSSGP). Although only one SGSN is shown, it is recognized that that multiple SGSNs 631 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 645, any given BSC 645 generally interfaces with one SGSN 632. Also, the SGSN 632 is optionally connected with the HLR 651 through an SS7-based interface using GPRS enhanced Mobile Application Part (MAP) or with the MSC 649 through an SS7-based interface using Signaling Connection Control Part (SCCP). The SGSN/HLR interface allows the SGSN 632 to provide location updates to the HLR 651 and to retrieve GPRS-related subscription information within the SGSN service area. The SGSN/MSC interface enables coordination between circuit-switched services and packet data services such as paging a subscriber for a voice call. Finally, the SGSN 632 interfaces with a SMSC 653 to enable short messaging finctionality over the network 650.

The GGSN 634 is the gateway to external packet data networks, such as the Internet 613 or other private customer networks 655. The network 655 comprises a Network Management System (NMS) 657 linked to one or more databases 659 accessed through a PDSN 661. The GGSN 634 assigns Internet Protocol (IP) addresses and can also authenticate users acting as a Remote Authentication Dial-In User Service host. Firewalls located at the GGSN 634 also perform a firewall finction to restrict unauthorized traffic. Although only one GGSN 634 is shown, it is recognized that a given SGSN 632 may interface with one or more GGSNs 633 to allow user data to be tunneled between the two entities as well as to and from the network 650. When external data networks initialize sessions over the GPRS network 650, the GGSN 634 queries the HLR 651 for the SGSN 632 currently serving a MS 641.

The BTS 647 and BSC 645 manage the radio interface, including controlling which Mobile Station (MS) 641 has access to the radio channel at what time. These elements essentially relay messages between the MS 641 and SGSN 632. The SGSN 632 manages communications with an MS 641, sending and receiving data and keeping track of its location. The SGSN 632 also registers the MS 641, authenticates the MS 641, and encrypts data sent to the MS 641.

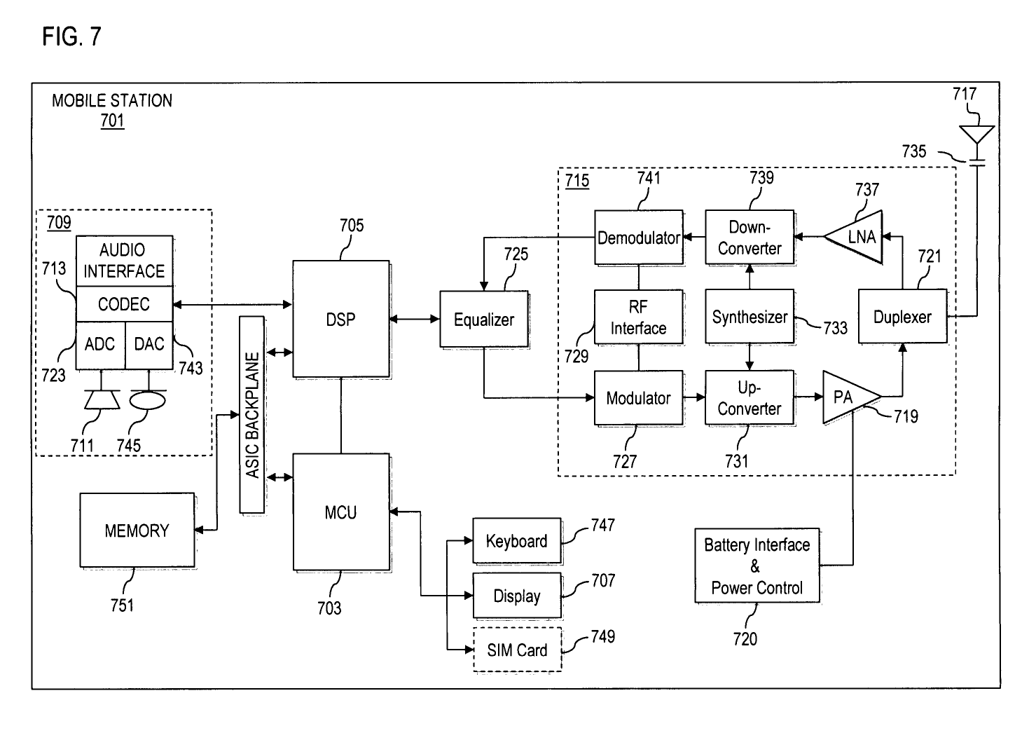

FIG. 7 is a diagram of exemplary components of a mobile station (e.g., handset) capable of operating in the systems of FIGS. 6A and 6B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile station finctions. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system (e.g., systems of FIG. 6A or 6B), via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile station 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TLA/ELA/IS-95-A Mobile Station-Base Station Compatibility Standard for Dual-Mode Wideband Spread Spectrum Cellular System; which is incorporated herein by reference in its entirety.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703—which can be implemented as a Central Processing Unit (CPU) (not shown).

The MCU 703 receives various signals including input signals from the keyboard 747. The MCU 703 delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control finctions required of the station. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile station 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile station 701 on a radio network. The card 749 also contains a memory for storing a personal telephone number registry, text messages, and user specific mobile station settings.

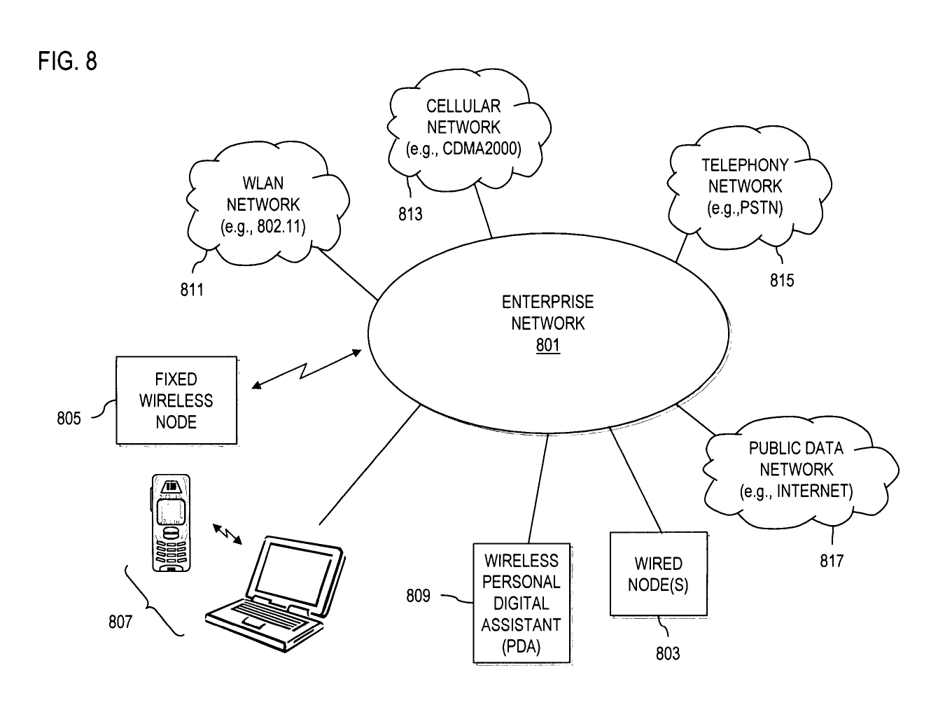

FIG. 8 shows an exemplary enterprise network, which can be any type of data communication network utilizing packet-based and/or cell-based technologies (e.g., Asynchronous Transfer Mode (ATM), Ethernet, IP-based, etc.). The enterprise network 801 provides connectivity for wired nodes 803 as well as wireless nodes 805-809 (fixed or mobile), which are each configured to perform the processes described above. The enterprise network 801 can communicate with a variety of other networks, such as a WLAN network 811 (e.g., IEEE 802.11), a cdma2000 cellular network 813, a telephony network 816 (e.g., PSTN), or a public data network 817 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

### Appendix

| | |
|---|---|
| 1XDO | Single Carrier Data Only/Optimized System |
| 3GPP2 | Third Generation Partnership Project 2 |
| AAA | Authentication, Authorization and Accounting |
| AGC | Automatic Gain Control |
| AKA | Authentication and Key Agreement |
| AN | Access Network |
| ASIC | Application Specific Integrated Circuit |
| AT | Access Terminal |
| AVP | Attribute Value Pair |
| BSC | Base Station Controller |
| BSF | Bootstrapping Server Function |
| BSS | Base Station Subsystem |
| BSSGP | BSS GPRS protocol |
| BTS | Base Transceiver Station |
| B-TID | Bootstrapping Transaction Identifier |
| CAVE | Cellular Authentication and Voice Encryption |
| C/I | Carrier to Interference |
| CDMA | Code Division Multiple Access |
| CD-ROM | Compact Disc - Read-Only Memory |
| CDRW | Compact Disc Read Writeable |
| CGF | Charging Gateway Function |
| CODEC | Coder/Decoder |
| CPU | Central Processing Unit |
| DAC | Digital to Analog Converter |
| DO | Data Only |
| DRC | Data Rate Control |
| DRX/DTX | Discontinuous Forward Link Reception and |
| | Reverse Link |
| DSC | Data Source Control |
| DSP | Digital Signal Processor |
| DVD | Digital Versatile (formerly Video) Disc |
| EAP | Encapsulation Authentication Protocol |
| EEPROM | Electrically Erasable Programmable Read- |
| | Only Memory |
| EPROM | Erasable Programmable Read-Only Memory |
| EV-DO | Evolution Data Only |
| FL | Forward Link |
| FQDN | Fully Qualified Domain Name |
| FPGA | Field Programmable Gate Array |
| GBA | Generic Bootstrapping Architecture |
| GBA_U | Key Bootstrapping Module |
| GGSN | Gateway GPRS Support Node |
| GPRS | General Packet Radio Service |
| HA | Home Agent |
| H-AAA | AAA in the home cdma2000 network-The home |
| | AAA server (H-AAA) is the AAA server managed |
| | by the home cdma2000 operator |
| HDR | High Data Rate |
| HLR | Home Location Register |
| HRPD | High Rate Packet Data |
| HSS | Home Subscriber System |
| ID | Index |
| IETF | Internet Engineering Task Force |
| IMT | International Mobile Telecommunications |
| IPSec | Internet Protocol Security |
| IR | Infrared |
| ITU | International Telecommunications Union |
| KDM | Key Derivation Module |
| KPM | Key Provisioning Module |
| LNA | Low Noise Amplifier |
| LSB | Least Significant Bit |
| MAC | Medium Access Control |
| MAP | Mobile Application Part |
| MC-HRPD | Multi-Carrier High Rate Packet Data |
| MCU | Main Control Unit |
| ME | Mobile Equipment |
| MIP | Mobile Internet Protocol |
| MS | Mobile Station |
| MSC | Mobile Switching Center |
| NAI | Network Access Identifier |
| NMS | Network Management System |
| NXDO | Multi-Carrier Data Only/Optimized System |
| OTA | Over the Air |
| PA | Power Amplifier |
| PCF | Packet Control Function |
| PCMCIA | Personal Computer Memory Card International |
| | Association |
| PCU | Packet Control Unit |
| PDIF | Packet Data Interworkmg Function |
| PDP | Personal Development Planning |
| PDSN | Packet Data Service Node |
| PN | Pseudo random Noise |
| PS | Packet Switched |
| PSK | Pre-Shared Key |
| PSTN | Public Switched Telephone Network |
| RA | Reverse Activity |
| RAB | Reverse Activity Bit |
| RAM | Random Access Memory |
| RAs | Routing Areas |
| RF | Radio Frequency |
| RFC | Request For Comment |
| RL | Reverse Link |
| RFC | Reverse Power Control |
| RRI | Reverse Rate Indicator |
| RTC | Reverse Traffic Channel |
| SA | Security Association |
| SC/MM | Session Control and Mobility Management |
| SCCP | Signaling Connection Control Part |
| SGSN | Serving GPRS Supporting Node |
| SIM | Subscriber Identity Module |
| SMSC | Short Message Service Center |
| SS7 | Signaling System Number 7 |
| TCH | Traffic Channel |
| TDMA | Time Division Multiple Access |
| TIA | Telecommunication Industry Association |
| | Transmission |
| TLS | Transport Layer Security |
| UATI | Unicast Access Terminal Identifier |
| UE/MN | User Equipment/Mobile Node |
| UICC | Universal Integrated Circuit Card |
| UIM | User Identity Module |
| UMTS | Universal Mobile Telecommunications System |
| USB | Universal Serial Bus |
| V-AAA | Visited AAA |
| VLR | Visitor Location Register |
| VoIP | Voice Over IP |
| WCDMA | Wideband-CDMA |
| WiMax | Worldwide Interoperability for Microwave Access |
| WLAN | Wireless Local Area Network |
| WLANAN | Wireless Local Area Network Node or Access Point |
| WLANIW | Wireless Local Area Network Inter Working |
| WKEY | Wireless Local Area Network Key |

What is claimed is:

1. A method comprising:
generating a session key, within a secure module of a communication device, to secure a communication session; and
forwarding the session key to an unsecure module of the communication device, the unsecure module being configured to execute an application that uses the session key to establish the communication session.

2. A method according to claim 1, further comprising:
receiving a request from the application within the unsecure module for the session key, the request specifying an application identification number, a secret, and a plurality of random numbers for use in generating the session key.

3. A method according to claim 2, wherein the session key is generated according to a Transport Layer Security (TLS)/Pre-Shared Key procedure.

4. A method according to claim 3, wherein the secure module is a User Identity Module (UIM), and the unsecure module is a Mobile Equipment (ME).

5. A method according to claim 3, wherein the secure module resides in a first device, and the unsecure module resides in a second device.

6. A method according to claim 3, wherein the communication session is established over a communication network that is either a spread spectrum cellular network or a wireless local area network.

7. An apparatus comprising:
a secure processor configured to generate a session key to secure a communication session, wherein the session key is forwarded to an unsecure module, the unsecure module being configured to execute an application that uses the session key to establish the communication session.

8. An apparatus according to claim 7, wherein the secure processor is further configured to receive a request from the application within the unsecure module for the session key, the request specifying an application identification number, a secret, and a plurality of random numbers for use in generating the session key.

9. An apparatus according to claim 8, wherein the session key is generated according to a Transport Layer Security (TLS)/Pre-Shared Key procedure.

10. An apparatus according to claim 9, wherein the secure processor resides within a secure module, the secure module being a User Identity Module (UIM), and the unsecure module being a Mobile Equipment (ME).

11. An apparatus according to claim 9, wherein the User Identity Module (UIM) includes a Key Derivation Module (KDM) and a Key Provisioning Module (KPM), the Key Derivation Module being configured to communicate with the application, and the Key Provisioning Module being configured to execute a pre-shared key application for generating a pre-shared key from which the session key is derived.

12. An apparatus according to claim 9, wherein the communication network is either a spread spectrum cellular network or a wireless local area network.

13. An apparatus comprising:
a secure module configured to generate a session key to secure a communication session; and
an unsecure module configured to receive the session key and to execute an application that uses the session key to establish the communication session.

14. An apparatus according to claim 13, wherein the unsecure module is further configured to generate a request for the session key, the request specifying an application identification number, a secret, and a plurality of random numbers for use in generating the session key.

15. An apparatus according to claim 13, further comprising:
a transceiver configured to receive user input to initiate establishment of the communication session; and
a display configured to display the user input.

16. A method comprising:
generating a request, by an application resident within an unsecure module of a communication device, for a session key to secure a communication session; and
forwarding the request to a secure module of the communication device, the secure module being configured to generate the session key in response to the request,
wherein the application resident within the unsecure module uses the session key to establish the communication session.

17. A method according to claim 16, wherein the request specifies an application identification number, a secret, and a plurality of random numbers for use in generating the session key.

18. A method according to claim 16, wherein the session key is generated according to a Transport Layer Security (TLS)/Pre-Shared Key procedure.

19. A method according to claim 16, wherein the secure module is a User Identity Module (UIM), and the unsecure module is a Mobile Equipment (ME).

20. A method according to claim 16, wherein the communication session is established over a communication network that is either a spread spectrum cellular network or a wireless local area network.

21. An apparatus comprising:
a non-secure processor configured to run an application to generate a request for a session key to secure a communication session, wherein the request is forwarded to a secure module that is configured to generate the session key in response to the request,
wherein the application uses the session key to establish the communication session.

22. An apparatus according to claim 21, wherein the request specifies an application identification number, a secret, and a plurality of random numbers for use in generating the session key.

23. An apparatus according to claim 21, wherein the session key is generated according to a Transport Layer Security (TLS)/Pre-Shared Key procedure.

24. An apparatus according to claim 21, wherein the secure module is a User Identity Module (UIM), and the unsecure module is a Mobile Equipment (ME).

25. An apparatus according to claim 21, wherein the communication session is established over a communication network that is either a spread spectrum cellular network or a wireless local area network.

26. An apparatus comprising:
means for securely generating a session key to provide security for a communication session; and
means for forwarding the session key to an unsecure module that is configured to execute an application that uses the session key to establish the communication session.

27. An apparatus according to claim 26, further comprising:
means for receiving a request from the application for the session key, the request specifying an application identification number, a secret, and a plurality of random numbers for use in generating the session key.
